(19) United States
(12) Patent Application Publication
(10) Pub. No.: US 2011/0219962 A1
(43) Pub. Date: Sep. 15, 2011

(54) YARD WASTE COMPACTOR

(76) Inventor: DUSAN IVKOVIC, Toronto (CA)

(21) Appl. No.: 12/722,943

(22) Filed: Mar. 12, 2010

(51) Int. Cl. B30B 1/00

(52) U.S. Cl. 100/265

(57) ABSTRACT

A compactor for compressing yard waste in a yard waste receptacle such as a leaf bag or garbage pail is disclosed. The compactor includes a press and a handle connected to the press. Force may be applied to the handle to cause the press to compress the yard waste in the yard waste receptacle so as to compact the yard waste and allow more yard waste to be added to the receptacle. A locking swivel bracket may be used to connect the handle to the press. The locking swivel bracket allows the handle to be held in a substantially perpendicular position for use in compacting yard waste or a substantially parallel position for storing the compactor or for guiding yard waste into a yard waste receptacle.

### FIELD OF THE INVENTION

The present invention relates to an apparatus for compressing and compacting leaves and other yard waste in a receptacle, and more particularly, to a yard waste compactor.

### BACKGROUND OF THE INVENTION

In many areas, leaves and other yard waste may be collected at the curb side by municipal or other yard waste collection services. Leaves and other yard waste, such as grass clippings, weeds, garden waste, twigs, prunings and small sticks may be placed in a receptacle such as a paper bag or a garbage pail for pickup.

When filling a yard waste receptacle, a person will often use their hands to press down on and compress the yard waste so as to compact it and create additional volume in the receptacle for additional yard waste to be added. Since the cross-sectional area of a yard waste receptacle is often larger than the human hand, a person may need to press down numerous times on the top of yard waste within the receptacle to compress and compact it a suitable amount. While compressing yard waste in this fashion may create additional volume in the receptacle, it may also cause in cuts to a person's hands and arms, or other injuries, from the small twigs, sticks, prunings or other hazards which may contained within the yard waste receptacle. A person using their hands to compress yard waste may also have to put down their rake or other tool that they were using to guide the yard waste into the receptacle. Having to put down and pick up a rake repeatedly during the yard waste collection process adds to the time required to collect the yard waste.

It would be desirable to more safely, effectively and efficiently compress and compact yard waste within a yard waste receptacle. Accordingly, there remains a need for improvements in the art.

### BRIEF SUMMARY OF THE INVENTION

According to one aspect, the present invention provides a compactor for compressing yard waste in a receptacle comprising: a press; and a handle operatively connected to the press, wherein force may be exerted on the handle to cause the press to compress the yard waste in the receptacle.

Other aspects and features according to the present application will become apparent to those ordinarily skilled in the art upon review of the following description of embodiments of the invention in conjunction with the accompanying figures.

### BRIEF DESCRIPTION OF THE DRAWINGS

Reference will now be made to the accompanying drawings which show, by way of example, embodiments of the invention, and how they may be carried into effect, and in which:

FIG. 1 is a perspective view of a yard waste compactor according to an embodiment of the present invention;

FIG. 2 is a top view of the press of FIG. 1;

FIG. 3 is a side view of a handle according to an embodiment of the present invention;

FIG. 4 is a perspective view of a foam sleeve employed in an embodiment of the invention;

FIG. 5 is a side view of a bracket employed in an embodiment of the invention;

FIG. 6 is a top view of the bracket shown in FIG. 5;

FIG. 7 is a side view of the bracket shown in FIG. 6;

FIG. 8 is a perspective view of a pin employed in an embodiment of the invention;

FIG. 9 is a side view of a press and a bracket according to an embodiment of the invention; and

FIG. 10 is a perspective view of a press including a retaining clip according to an embodiment of the invention.

Like reference numerals indicate like or corresponding elements in the drawings.

### DETAILED DESCRIPTION OF THE EMBODIMENTS

Embodiments of the present invention are generally directed to a yard waste compactor for compressing leaves and other yard waste in a receptacle.

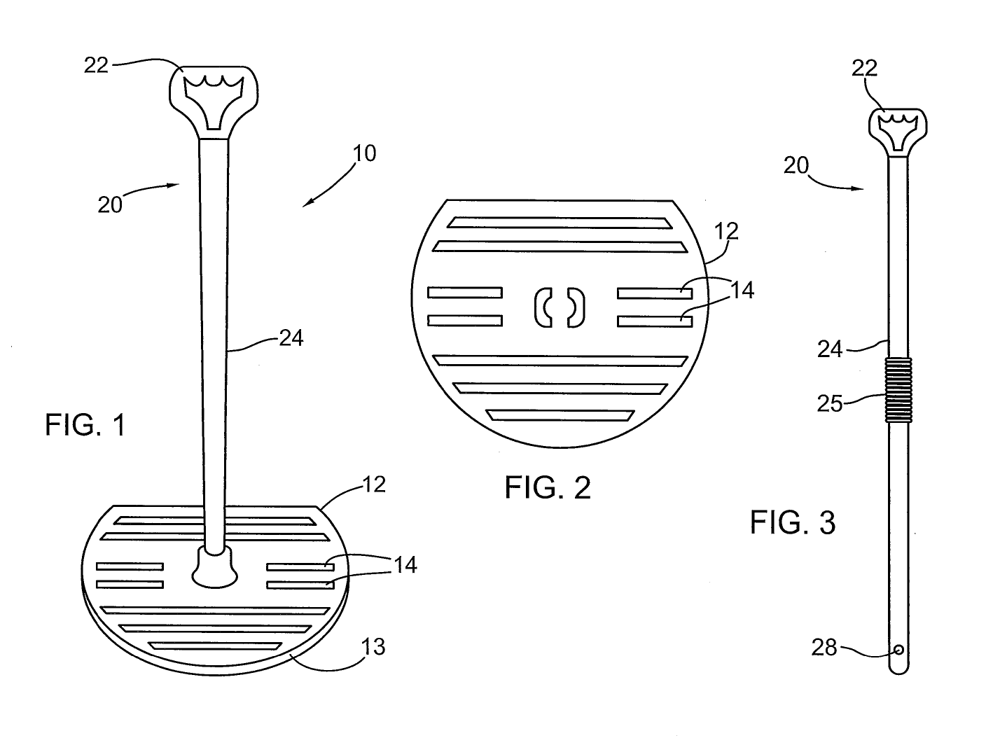

According to an embodiment as shown in FIG. 1, the yard waste compactor 10 comprises a press 12 operatively connected to a handle referred to generally as 20. The press 12 may be made of plastic or metal or other suitable material as known in the art. According to an embodiment shown in FIG. 1, the press may be substantially circular in shape, however many other shapes may be beneficially employed according to embodiments of the invention. According to an embodiment, the peripheral edge 13 of the press 12 may be partially rounded or fully rounded so as to reduce the chance of tearing or otherwise damaging the paper bag or other yard waste receptacle. The press may comprise one or more vents 14, as shown in FIGS. 1 and 2, through which small solid material, liquid or gas, such as air, may pass when the press is used to compress yard waste. This may assist with compressing yard waste as air may escape through the vents 14 rather than be compressed with the yard waste and potentially causing the receptacle to burst under the increased pressure.

According to embodiments as shown in FIG. 1 and FIG. 3, the handle 20 may comprise a gripping portion 22 and a shaft portion 24. The gripping portion 22 may be made of plastic, fibreglass, wood or other suitable material. The shaft portion 24 may be made of plastic, fibreglass, wood, such as a light and strong wood such as ash, or other suitable material. According to an embodiment, the shaft portion 24 may include a knurled area 25 that may enhance gripping of the handle 20. According to a further embodiment, the shaft portion 24 may be substantially or partially enclosed in a foam sleeve 26, such as shown in FIG. 4, or other suitable material which may make the handle 20 more comfortable for the user to hold or may reduce the occurrence of calluses to user's hands. According to an embodiment, the gripping portion 22 may also be covered with foam or other suitable material as desired.

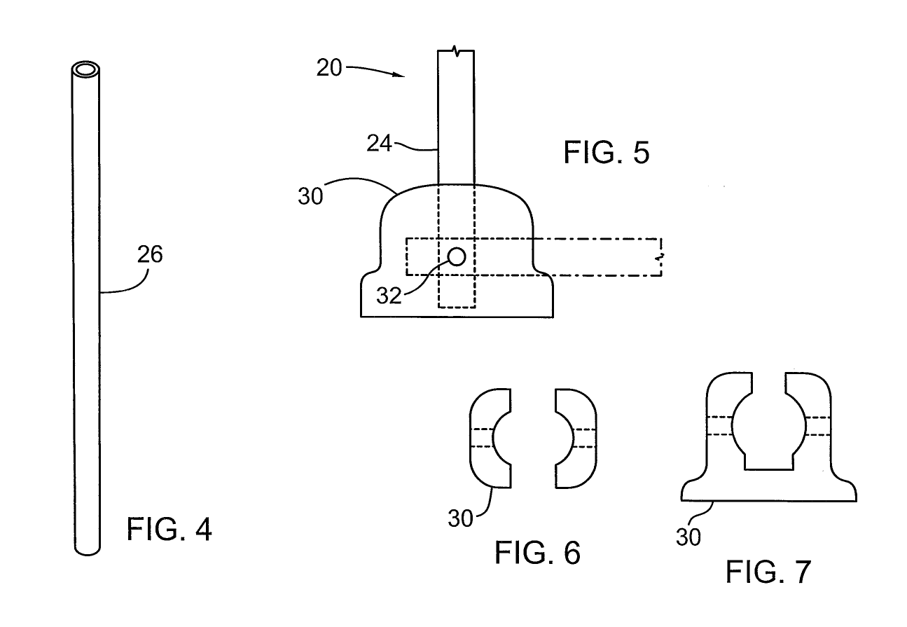

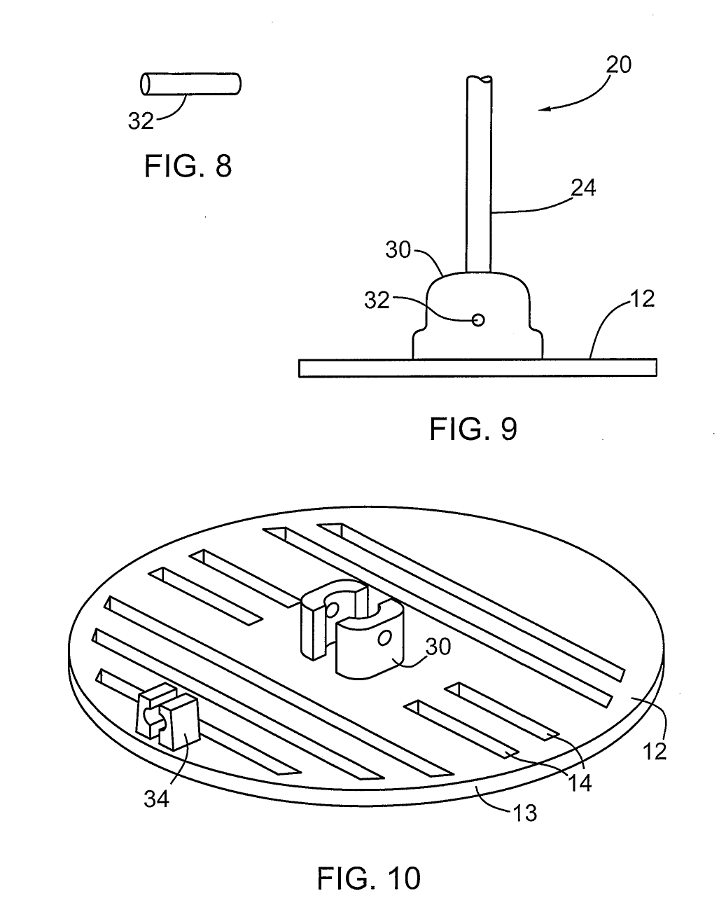

According to embodiments as shown in FIGS. 5 to 10, the handle 20 may be operatively connected to the press 12 by a bracket, such as locking swivel bracket 30. The locking swivel bracket 30 receives the handle 20 and a pin 32 which passes through a hole 28 in the handle 20. The hole 28 may be particularly sized and shaped to receive the pin 32. According to an embodiment as shown in FIG. 5 and FIG. 7, the locking swivel bracket 30 may be shaped to hold the handle 20 in a first position substantially perpendicular to the press 12. The first position for the handle 20 may be used when compressing yard waste in a yard waste receptacle in that the user applies a force on the handle 20 to cause the press 12 to compress the yard waste in the receptacle. According to an embodiment, the handle 20 may be held in the first position by sizing the space in the upper portion of the bracket 30 such that the handle 20 frictionally engages the bracket 30 in a manner which resists relative motion between the handle 20 and the bracket 30 and therefore requires a sufficient lateral force to be applied to the handle 20 to dislodge it from the first position. The required lateral force should be enough that the handle 20 does not dislodge from the first position when the compactor 10 is used to compact yard waste, but not so great as to make it difficult for the user to dislodge the handle 20 from the first position when lateral force is intentionally applied to the handle 20 by the user.

As shown in FIG. 5 and FIG. 6, the locking swivel bracket 30 may also be shaped to hold the handle 20 in a second position substantially parallel to the press 12. The second position for the handle 20 may be used to assist in collecting yard waste, for example, by using the press 12 opposite a rake to guide yard waste into the yard waste receptacle. Similarly, yard waste may be raked on top of the press 12, and the compactor 10 then used to lift the yard waste on top of the press 12 into the yard waste receptacle. The second position may also be used when storing the yard waste compactor 10. According to an embodiment, the handle 20 may be held in the second position by sizing the space in one or both of the lateral portions of the bracket 30 such that the handle 20 frictionally engages the bracket 30 in a manner which resists relative motion between the handle 20 and the bracket 30 and therefore requires a sufficient lateral force to be applied to the handle 20 to dislodge it from the second position. The required lateral force should be enough that the handle 20 does not dislodge from the second position when the compactor 10 is used to guide yard waste into a receptacle, but not so great as to make it difficult for the user to dislodge the handle 20 from the second position when lateral force is intentionally applied to the handle 20 by the user. According to a further embodiment as shown in FIG. 10, in addition to, or instead of, the frictional engagement described above holding the handle 20 in the second position, a retaining clip 34 on the press 12 may receive and retain the handle 20 in the second position until a sufficient lateral force is applied to the handle 20 to dislodge it from the second position.

According to an embodiment, the handle 20 may be adjusted between the first position and the second position by the user applying a lateral force to the handle 20, which then swivels about the pin 32 passing through the hole 28 in the handle 20 and retained in the bracket 30.

According to a further embodiment as shown in FIG. 1, the handle 20 is fixed to the press 12 and may not swivel.

Embodiments of the present invention may therefore allow a user to compress and compact leaves and other yard waste in a leaf bag, garbage pail or other yard waste receptacle more safely, effectively and efficiently. According to an embodiment, the handle 20 may be provided of sufficient length to allow a user to compact yard waste in a receptacle without having to bend over which may make yard waste compaction more comfortable for the user as well as potentially reduce the risk of back injury. As described above, embodiments of the present invention may also be employed to hasten the collection of yard waste into a yard waste receptacle by using the compactor to guide raked yard waste into the yard waste receptacle.

The present invention may be embodied in other specific forms without departing from the spirit or essential characteristics thereof. Certain adaptations and modifications of the invention will be obvious to those skilled in the art. Therefore, the presently discussed embodiments are considered to be illustrative and not restrictive, the scope of the invention being indicated by the appended claims rather than the foregoing description, and all changes which come within the meaning and range of equivalency of the claims are therefore intended to be embraced therein.

What is claimed is:

1. A compactor for compressing yard waste in a receptacle comprising:
a press; and
a handle operatively connected to the press, wherein force may be applied to the handle to cause the press to compress the yard waste in the receptacle.

2. The compactor of claim 1, wherein the handle comprises a shaft portion.

3. The compactor of claim 1, wherein the handle comprises a gripping portion.

4. The compactor of claim 1, wherein the handle is adjustable between at least a first position substantially perpendicular to the press and a second position substantially parallel to the press.

5. The compactor of claim 2, further comprising a sleeve substantially enclosing at least some of the shaft portion.

6. The compactor of claim 5, wherein the sleeve comprises foam.

7. The compactor of claim 1, wherein the press comprises one or more vents.

8. The compactor of claim 1, wherein a bracket operatively connects the handle to the press.

9. The compactor of claim 8, wherein the bracket is a locking swivel bracket.

10. The compactor of claim 9, wherein a pin retained in the bracket passes through a hole within the handle.

11. The compactor of claim 9, wherein the bracket is shaped to hold the handle in a first position substantially perpendicular to the press by frictional engagement.

12. The compactor of claim 9, wherein the bracket is shaped to hold the handle in a second position substantially parallel to the press by frictional engagement.

13. The compactor of claim 4, further comprising a retaining clip on the press to retain the handle in the second position.

14. The compactor of claim 1, wherein the press further comprises a peripheral edge which is at least partially rounded.

15. The compactor of claim 2, wherein the shaft portion of the handle comprises a knurled area.
